(19) United States
(12) Patent Application Publication
(10) Pub. No.: US 2012/0178956 A1
(43) Pub. Date: Jul. 12, 2012

(54) METHOD FOR PREPARING A FUNCTIONAL STRUCTURED SURFACE AND SURFACE OBTAINED BY SAID METHOD

(76) Inventors: Sandrine Dourdain, Tresques (FR); Pierre Terech, Saint-Cassien (FR)

(21) Appl. No.: 13/395,232

(22) PCT Filed: Sep. 8, 2010
(86) PCT No.: PCT/FR10/51874

§ 371 Date: Mar. 9, 2012

(30) Foreign Application Priority Data
Sep. 11, 2009 (FR) 0956277

(51) Int. Cl. C07F 7/02; B29C 67/20; H01F 1/42; B24B 1/00; B82Y 40/00; B82Y 30/00

(52) U.S. Cl. 556/417; 252/62.51 R; 451/28; 264/136; 216/94; 977/700; 977/840; 977/895

(57) ABSTRACT

A method for preparing a functional structured surface includes the controlled removal of material from a film including at least one buried pore, the inner surface of the pore including at least one chemical linkage group, where the material is removed so as to expose part of the inner surface of the pore that is not affected by the removal of material.

### PRIORITY CLAIM

This application is a nationalization under 35 U.S.C. §371 of PCT Application No. PCT/FR2010/051874, filed Sep. 8, 2010, which claims priority to French Patent Application No. 0956277, filed Sep. 11, 2009, and is incorporated by reference herein.

### TECHNICAL FIELD

The present invention relates to a method for preparing a functional structured surface, and a surface obtained by said method and, more particularly, to the controlled positioning of nano-objects on a surface.

### BACKGROUND

Currently there are endeavours to develop functional objects with dimensions in the range from the molecular scale to the nanoscale in large quantity and at lower cost. These objects can be produced by chemical methods or by physical methods.

However, to be fully exploitable these nano-objects (nanoparticles, nanowires, nanotubes for example) must be manipulable and accessible. In particular it is necessary to know their localization or their orientation, relative to one other, and relative to a macroscopic coordinate system.

Whether for applications in biology, molecular electronics or in nano-magnetism, the controlled positioning of nano-objects on a surface is therefore a major technological challenge. Various technologies have been envisaged and some that have been implemented have been described.

The tip of an AFM (atomic force microscope) can for example provide localized deposition or specific grafting of particles. However, this approach is only applicable for positioning a limited number of particles on a surface.

On a larger scale, surfaces nanostructured by electron beam or focused ion beam lithography or by nano-imprint lithography (thermoplastic, by photoactivation or otherwise) can be used for locating particles, present in solution or in a gas phase. In this context, PCT publication No. WO 2008/012923 (Harvard) presents a method of manufacture of a nanostructure based on the encapsulation of a metallic, organic or semiconductor material on an indented surface followed by cutting of the encapsulating material, carried out so as to create an isolated nanostructure of a material of interest.

The self-assembly of amphiphilic molecules makes it possible, moreover, to generate macroscopic structured surfaces having units that are smaller (from 2 to 100 nm) and are organized. Structured organic surfaces are in particular formed by the annealing of surfactants (for example Aisson et al., Surface Science 2007, 601, 2611). Unfortunately, the proposed techniques do not allow selective functionalization of the units, hence it is difficult to control the positioning of nano-objects on these surfaces.

The encapsulation of nanoparticles directly in micelles of surfactants also makes it possible to generate organized networks of particles on large areas. Thus, PCT publication No. WO 2008/125172 (Max Planck Gesellschaft and Heidelberg University) describes a method involving the immersion of a substrate in a solution of multiblock copolymer laden with a metallic species, the gradual extraction of the substrate from the solution then a step of reduction or oxidation of the metal compound so as to form nanoparticles.

The self-organization of nanoparticles on a surface obtained on the basis of interactions between particles is also used on large areas, utilizing substrates pre-structured by lithographic methods. In this connection, PCT publication No. WO 2006/051186 (CEA) describes a method comprising the deposition of particles on a substrate with self-organization of the particles and modulated interaction between the substrate and the particles. For its part, U.S. Pat. No. 7,164,209 (Nanosys Inc.) describes the use of a mask combined with alignment by the action of a gas stream or of the nanoparticles that are to be arranged.

However, these last-mentioned methods only offer a barrier of limited potential between the particles, which leads to the formation of agglomerates, in particular under the external action of annealing.

Furthermore, mesoporous inorganic layers are known, using the organization of lyotropic phases. U.S. Pat. No. 6,326,326 (Battelle Memorial Institute) describes a method involving the hydration of a mesoporous material, mixing the material with precursors of functional molecules, agitation in order to cause the precursors to permeate through the pores, and heating. It should be pointed out in this connection that the category of mesopores is defined by IUPAC as including pores with width between 2 and 50 nm, smaller pores being described as micropores, and larger pores as macropores (see for example Pure & Appl. Chem., Vol. 57, No. 4, pp. 603-619, 1985).

Moreover, synthesis of functionalized ordered and mesoporous films of silicon alkoxides, based on self-assembly induced by evaporation, is known from the document “First Direct Synthesis of highly ordered bifunctional mesoporous silica thin films” by Mehdi et al., J. Nanosciences and Nanotechnology 6, 377, 2006. Preparation of a film of mesoporous silica with enlarged pores is also known from the document “Ordered large-pore mesoporous silica film with Im3m symmetry synthesized in ternary copolymer-butanol-water system” by Fang et al., Materials Letters, 60, 5, 2006, 581-584.

However, the external surface of these mesoporous layers generally has neither structuring, nor selective functionalization, and cannot be used for the controlled arrangement of nano-objects.

In another connection, a study of the behaviour of a film of mesostructured silica when subjected to chemical etching is also known from the document “Grating induced micelle alignment of mesostructured silica films”, Applied Physics Letters, 91, 2, 2007. A study of the effect of subjecting films of mesoporous silica to attack by a soda solution, suggesting the existence of several stages before final collapse of the film, is also known from the document “On the etching of silica and mesoporous silica films determined by X-ray reflectivity and atomic force microscopy”, Thin solid films, 517, 9, 3028, 2009.

The methods used in these studies do not permit controlled removal of material, and quickly destroy the porous structure of the layer.

A study of the mechanism of formation of pits obtained by thermal treatment of a structured layer of titanium oxide is also known from the document “Surface Nanopatterning by Organic/Inorganic Self-Assembly and Selective Local Functionalization”, Small, 2006, 2, 587. The calcining step breaks down any fragile chemical groups that may be present and no subsequent use of the external surface can be envisaged.

The present invention solves these problems.

### DETAILED DESCRIPTION

In order to solve the problems mentioned above, the invention proposes a method for preparing a structured surface comprising a material removal step applied to a material comprising at least one buried pore. The removal of material is carried out in such a way that a portion of the internal surface of the pore, unaffected by the removal of material, is rendered accessible. This can be achieved by adapting the conditions of duration, intensity and direction of the removal of material. The internal surface of the pore comprises chemical anchoring groups.

It should be noted that in general the chemical anchoring groups in question can be presented as flush with or projecting from the internal surface of the pore. They can be connected to the bulk of the material by a spacer, which can be short or long, branched or linear. Typically, a spacer corresponds to a structure that increases the distance of the chemical anchoring group from the material and permits the effects of steric hindrance to be avoided. The structure of the spacer group has low reactivity with its environment, and it can for example correspond to a chain of the alkyl or cycloalkyl type.

The removal of material can be carried out by a physical, chemical or physicochemical treatment of abrasion, preferably with a rate of abrasion of the order of a few nm per minute (less than 5 nm.s⁻¹, or even less than 1 nm.s⁻¹), and a horizontality of less than 10%, or even 5%, or 2.5% (defined as the difference between the highest point and the lowest point of the surface, relative to the thickness removed).

Abrasion can be carried out by means of a liquid under pressure such as water, an organic solvent or nitrogen, optionally in combination with ultrasound, or a gas such as compressed air.

Abrasion can be carried out with an abrasive—i.e. a product in the form of finely divided solid particles—alone or in a carrier liquid (such as water) or a carrier gas (such as compressed air). The abrasive can be inorganic or organic.

Abrasion can also be carried out with particles of a chemical entity that is, under normal conditions of temperature and pressure (25° C., 1 atmosphere), more stable in the gaseous form than in other forms, for example “dry ice” in the solid state or in the supercritical state.

Furthermore, it can be carried out by means of electromagnetic radiation of the laser beam or microwave type, which has the effect of inducing a change in the physical parameters of the surface to be treated, such as its temperature, which can lead to the vaporization and dispersion of this surface.

Finally, abrasion can be mechanical, induced by a solid surface of an instrument carrying out a polishing operation. It can also be carried out by a chemical method in solution, or by a dry chemical method, or by annealing.

The use of a pore and of appropriate abrasion makes it possible to obtain a nanostructured surface while preserving anchoring groups, which are then accessible. The use of an anisotropic abrasion technique, i.e. in which the medium surrounding the material comprising at least one pore undergoes non-isotropic or oriented movements (presence for example of a flow), is advantageous in this context.

The portion of the pore that is unaffected and is rendered accessible is then called a cell. It can have the geometry of a fraction of a sphere.

By “rendering the internal surface of the pore or of the cell accessible” is meant increasing the solid angle through which an object can reach the surface by moving in a straight line from the exterior of the material without encountering an obstacle.

Abrasion creates an opening in the pore, through which the cell is accessible from the exterior of the material. The entire process for treatment of the material is carried out so as to release a surface, described as a structured surface as it comprises at least the cell. This surface can be flat, or can have a curvature.

The invention applies to the industrial fields of molecular electronics, nano-electronics, magnetism, nano-optics, biology (in particular DNA chips), and chemistry (catalysis, chemical sensors).

The anchoring groups are chemical functions that can be used for specifically anchoring nano-objects, thus allowing them to be positioned in a cell, or even to be organized if several cells form an organized network. The anchoring groups display physicochemical affinity for nano-objects.

It is generally considered that there is affinity between a anchoring group and a nano-object when it is possible to correlate the duration of contact between a nano-object suspension and a surface bearing anchoring groups with a decrease in the concentration of nano-objects within the suspension, a plateau value generally being reached, independently of any demixing of the nano-objects in the suspension.

It is thus possible to determine nano-object/anchoring group pairs, between which there is affinity. The affinity is generally due to interactions of the weak or strong type that develop between the surface of the nano-objects and the anchoring groups. Among the interactions of the weak type, we may in particular mention hydrogen bonds, bonds of the ionic type, complexation bonds, pi interactions (“pi stacking”), van der Waals bonds, hydrophobic bonds (or nonpolar bonds of the surfactant type); among the strong bonds, we may mention the covalent bonds that can form spontaneously.

Among the chemical functions that can be used in this context, we may in particular mention amine, nitrile, thiol functions or functions comprising phosphors.

A nano-object is an object of nanometric size, the largest dimension of which is less than 1 μm and typically less than 100 or 25 nm. It can in particular be a nanoparticle, a nanocrystal, a nanowire or a nanotube or a nanocolumn. Such a nano-object can be organic or inorganic and can be in solution or in the gas phase. It can comprise one or more organic ligands on the surface.

The nano-objects used within the context of the invention advantageously have a size smaller than the average size of the opening made in the pore during the abrasion step, which allows them to penetrate therein.

According to an advantageous feature, the method therefore further comprises a step of positioning of nano-objects on the structured surface.

Thus, a surface is obtained having nano-objects positioned in the structure in the surface relief, for example on the internal surface of the pore rendered accessible at the surface (the cell).

This offers the advantage of an important potential barrier for the positioning of the nano-objects.

According to an advantageous feature, the positioning comprises deposition by impregnation, for example in solution.

According to an advantageous feature, the treated material contains, before the treatment, a buried layer of pores, and the removal of material is carried out so that a portion of the respective internal surfaces of the pores of the layer is rendered accessible. The latter can be flat, but also can have a curvature.

Optionally, the layer contains an ordered network of pores. A structured surface comprising an ordered network of cells is then obtained. By arranging nano-objects in this network of cells, controlled positioning of these nano-objects is achieved, which are accessible and manipulable, since they are disposed in the cells, the arrangement of which is known.

According to an advantageous feature, the material removed during the abrasion step is a continuous layer, which is opposite, relative to the plane of the layer of pores, to a subjacent zone of particular functional interest, rendered accessible by said removal of material.

Thus, starting from a material that has volumetric organization, we obtain a surface of structured relief with controlled structural characteristics, and offering accessibility to a subjacent zone of interest in the material. Depending on the applications, the zone of interest to which new accessibility is thus offered is a zone of the treated material, or a zone of a support on which the treated material is placed or was synthesized.

According to an advantageous feature, removal of material is carried out by abrasion by a beam, for example an ion beam, applied with controlled incidence. The angle of incidence is preferably between 0 and 10°, or preferably between 0 and 5°, or even between 0 and 2° relative to a reference surface of the material, for example parallel to the layer of pores, if the latter is flat. For these low values of angle, the incidence is described as grazing.

By removing material around the pores, abrasion by a beam, for example by an ion beam, generates nanostructured surfaces on macroscopic dimensions. This abrasion technique makes it possible, moreover, to preserve the chemical functions specifically present on the surface of the pores.

Ion-beam abrasion can be applied with a beam of argon, of oxygen or another type of gas providing suitable rates of abrasion.

According to an advantageous feature, the material comprising at least one pore is formed beforehand by evaporation of a solvent after deposition on a substrate or support, for example by spin coating or by dip coating, of a liquid solution containing a precursor of said material comprising at least one pore, the precursor having meanwhile undergone a condensation reaction.

The method for preparing the material can thus involve firstly a phenomenon of transformation of the material of the liquid solution into solid material, during which the reacting matter undergoes physicochemical reactions, involving for example phase changes or a sol-gel condensation phenomenon, which lead to the acquisition of a solid structure by the matter.

For example, the material contains a plurality of mesopores, and is described as mesoporous material. According to an advantageous feature, the solvent comprises one or more surfactants for this. A step of reaction of the solution of precursor in the presence of a surfactant or surfactants then constitutes a structuring step, which determines the geometry of the mesoporous material.

Owing to the surfactant selected, a particular, known and controlled geometry is obtained, with suitable distances between pores, and a suitable pore size.

Alternatively, the structuring of the material can also be induced electrochemically. For example, a potential applied to an electrode immersed in a solution containing surfactants and silica sol generates hydroxyl ions for catalysing the reaction of polycondensation of the silica precursors around the self-assembled surfactants. The potential thus triggers the growth of a mesostructured layer directly on the electrode surface.

According to an advantageous feature, the liquid solution from which the material is synthesized contains molecules capable of reacting with the precursor for spontaneous placement of a anchoring group on the surface of the pores. This is then called direct synthesis.

For example, these molecules comprise a group for fixation in the material, capable of condensing with the precursor molecules of the material and a chemical function for linkage or complexation, capable of serving as a anchoring group for a nanoparticle on the structured surface once this molecule is rendered accessible by the material removal step.

According to an advantageous feature, the material comprises spherical pores. Alternatively or in combination, the material comprises cylindrical pores whose directrix is preferably substantially parallel to the surface of the support on which the material is deposited, as appropriate.

The spherical and cylindrical units can have diameters between 2 and 50 nm. The distance between the units can vary between 1 and 50 nm, or between 2 and 10 nm.

According to an advantageous feature, alternative to direct synthesis but also combinable therewith, the method comprises a functionalization step, which can be carried out by impregnation of the material to be treated, before the material removal step, in a solution containing at least one entity having a chemical anchoring group capable of reacting with the surfaces of said material, or a precursor thereof. As said functionalization step is subsequent to the material structuring (or synthesis) step, it is described as post-synthetic. It is in particular subsequent to formation of the pore or pores.

According to another embodiment, direct synthesis leads to a material having at least one pore comprising at least one chemical anchoring group precursor, which is converted subsequently to the chemical anchoring group. The precursor and the chemical anchoring group are typically separated by a limited number of chemical steps, generally not more than two.

Such a step makes it possible to prepare the material comprising at least one pore, with chemical functions that can serve as anchoring group in the pores which can be different from those which can be obtained by direct synthesis. The anchoring groups obtained by direct synthesis can also be modified (completely or partially) by a post-synthetic reaction.

According to an advantageous feature, the material removal step is carried out so as to render accessible, via the internal space of the pore, a surface of a support on which the material to be treated was previously deposited, or synthesized. It is thus possible to take advantage of the physical or chemical characteristics of the material of the support or carry out a transformation of the support via the internal space of the pore. This is an example of a subjacent zone of particular functional interest that is rendered accessible.

According to an advantageous feature, the method also comprises a step of chemical functionalization of the surface of the support thus rendered accessible. This functionalization can be carried out before or after the material removal step.

According to another advantageous feature, the method comprises a step of removal of residues of the material after a step of positioning of nano-objects on the structured surface.

According to an advantageous feature, the material comprising at least one pore is selected from porous materials of the family of metal oxides such as oxides of silicon (SiO₂), titanium (TiO₂), zinc (ZnO) or aluminium (Al₂O₃). It can be a mesostructured hybrid organic/inorganic porous material. It can contain elements of addition having a functional or structural role, or traces resulting from the manner of synthesis.

According to an advantageous feature, the material also comprises a functionalization in its bulk (i.e. buried chemical groups at least capable of exchanging charges) buried at some distance from the surfaces of the material, whether they are the internal surfaces of the pores or the external surfaces of the material. This functionalization can have been obtained by direct synthesis, and can serve for carrying out physical or physicochemical reactions with nano-objects positioned on the structured surface.

The invention also relates to the surface obtained by the method presented.

The invention will now be described in detail, referring to the following attached figures.

### BRIEF DESCRIPTION OF THE DRAWING

FIG. 1 shows a first step of a variant of the method according to the invention.

FIGS. 2 to 5 show subsequent steps of the method presented in FIG. 1.

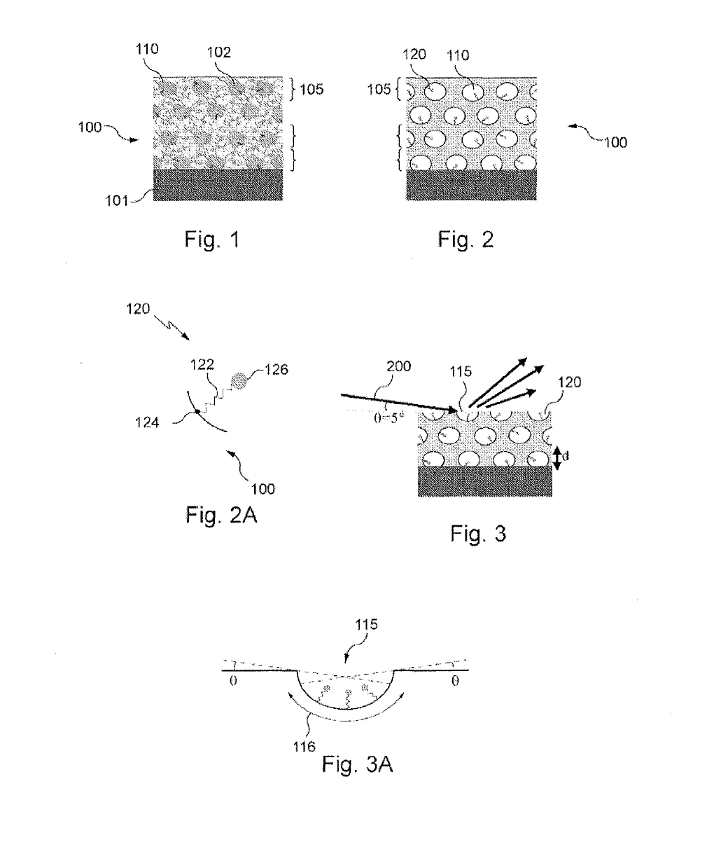

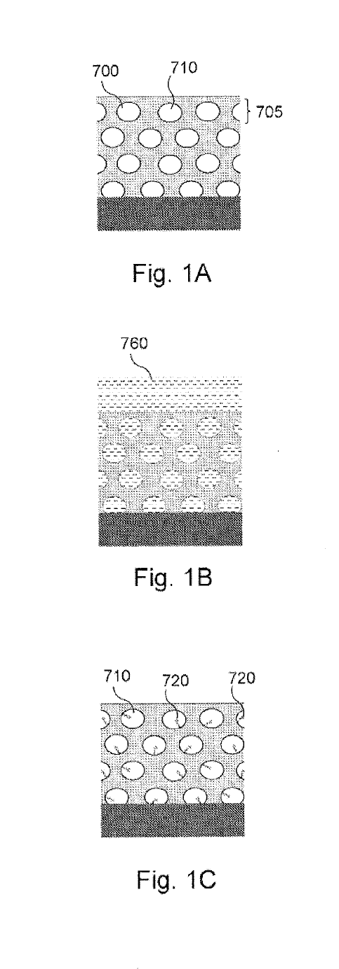

FIGS. 1A to 1C show an alternative to the embodiment in FIG. 1.

FIGS. 2A and 3A are details relating to FIGS. 2 and 3.

FIGS. 6 to 9 present different characterizations of the material used during the method.

FIGS. 11 and 12 present different characterizations of the surface produced at the end of the method, FIG. 10 showing the characterization of a control surface, to be compared with FIG. 11.

FIGS. 13 to 15 show one aspect of an embodiment of the invention.

FIGS. 16 to 20 show an alternative embodiment of the invention.

FIGS. 21 to 24 show another embodiment of the invention.

FIGS. 25 and 26 also show another embodiment of the invention.

### DETAILED DESCRIPTION

Referring to FIG. 1, thin films 100 of silica having cubic arrangements of spherical pores are prepared. The films 100 of mesoporous silica are synthesized by dip coating a silicon substrate or support 101. They are structured by surfactant F127 102 belonging to the family of triblock copolymers, permitting spherical pores 110 to be formed with a diameter of 6 nm. The dip coating solution is prepared in two steps. In a first step, the silica precursor (tetraethoxysilane, designated TEOS hereinafter) is pre-hydrolysed in a solution of water, hydrochloric acid and ethanol, called “stock solution”. The pH of this solution is preferably selected to be of the same order of magnitude as the isoelectric point of silica (ip equal to 2 and typically the pH is therefore between 1.2 and 2.6), which makes it possible to hydrolyse alkoxides by slowing down the mechanisms of condensation. The stock solution is stirred for 1 hour.

Once hydrolysed, the solution is added to the micellar solution of F127, consisting of the surfactant dissolved in ethanol.

The silicon substrate is dipped in the resultant solution consisting of the following stoichiometric fractions: 1 TEOS to 32 EtOH, 5 H₂O, 0.005 HCl and 0.004 F127. The final solution is stirred for 1 h.

The substrates covered with films 100 are then withdrawn from the solutions at a constant speed of 14 cm.min⁻¹, the total thickness of the film formed then being of the order of 100 nm. They are then dried at 80° C. for 4 days to improve their mechanical strength and then rinsed with ethanol for 2 h at 80° C. to extract the structure-forming surfactants 102 (FIG. 2). The spherical pores 110 are organized according to Im3m cubic symmetry, involving the presence of superposed layers 105 of mesoporous silica.

In the embodiment that is described here in detail, chemical functionalization of the pores 110 is carried out by direct synthesis. At the time of preparation of the films 100, during the step of pre-hydrolysis of the silica precursors, within the latter, a fraction of functionalized precursors is included, here a molecule 120 with a cyanopropyl function (cyanopropyl triethoxysilane). The fraction is preferably 10% (stoichiometric ratio with respect to TEOS).

It should be noted here that these molecules 120 comprise a propyl arm 122 (but it could have a different length) which displays satisfactory affinity for the surfactant, and acts as a spacer between the triethoxysilane group serving for fixation in the silica bulk (film 100) and the cyano function 126 which can be used as a anchoring group. This is illustrated in FIG. 2A. These molecules condense with the TEOS and are therefore inserted covalently in the silica network.

The surfactant is extracted by rinsing with a solvent such as ethanol, which provides best preservation of the molecules 120. The latter are then grafted specifically to the surface of the pores (FIG. 2). For clarity, only one molecule 120 per pore and cell is shown.

Referring to FIG. 3, abrasion of the mesoporous layers 105 is carried out by application of a beam of Argon 200 obtained with a Plassys MU400 Argon gun COPRA. The source PBS COPRA DN160CF is generated by a radiofrequency wave at 13.56 MHz of maximum power 600 W.

The thicknesses etched are controlled by the pressure of the argon gas, by the power P_{rf} of the radiofrequency wave generating the beam 200, and by the etching time. In one embodiment, a pressure P(Ar) of 1.2×10⁻⁴ torr, a source power P_{rf} of 300 W, and a duration of 240 s are used.

The dimensions of the beam 200 are greater than the lateral dimensions of the film 100, with the result that the whole film 100 is treated simultaneously, although as an alternative, film 100 could be treated by a narrow beam moving over the entire surface to be treated.

Moreover, film 100 follows a regular rotary movement through 360° during its treatment, so that the treatment is carried out homogeneously according to a rotational symmetry. It will be understood that, as an alternative, beam 200 can follow a rotary movement.

This protocol makes it possible to deliver rates of abrasion of 0.2 nm per second with a horizontality of the order of 4.3% on areas of 10 cm².

Opening of the first layers 105 of pores and abrasion of the silica walls by an ion beam then make it possible to keep the molecules 120 grafted in the open pores, called cells 115, if the beam 120 is applied with grazing incidence, for example about 5° (FIG. 3), owing to a shading effect created by the combination of the inclination of the beam and the presence of the cavity that the pore constitutes. The shading is caused by the mass of silica around the pore. This is illustrated in FIG. 3A, where reference 116 shows the surface of the cell 115 which has not been touched by the beam 200 at the moment when the treatment is stopped.

The technique of X-ray reflectivity is used for characterizing the thickness of the layers 105 at subnanometric scales. The curves of reflectivity measured before and after etching for 240 s are presented in FIG. 6 (curves 500 and 510 respectively). The measurements of X-ray reflectivity were carried out with a Philips Xpert reflectometer using the K□ radiation of a cobalt anode, of wavelength 1.789 Å.

The three Bragg peaks indicated by arrows for the etched film 100 are due to the periodicity of the layers of pores 105 in the direction perpendicular to the plane of the substrate.

The final thickness of the film 100 produces Kiessig fringes, whereas the periodicity of the layers 105 generates Bragg reflections (situated at q_{z} values of 0.067, 0.13 and 0.20 Å⁻¹ for the unetched film). Analysis of the Kiessig fringes shows that the thickness decreased from 101 nm to 65.8 nm after exposure to the beam 200. The film 100, initially consisting of 11 layers 105 of pores, thus sees its thickness reduced to 8 layers 105 after abrasion.

The position of the Bragg peaks is only slightly shifted after treatment (to about 0.075, 0.14 and 0.22 Å⁻¹), which shows that the latter did not greatly alter the periodicity of the layers perpendicular to the surface. The position of the Bragg peaks indicates that the thickness of the layers 105 (FIG. 2 before etching, and FIG. 3 after etching) is equal to 9.4 nm and 8.5 nm before and after etching respectively. This small difference is attributed to a slight distortion of the spherical shape of the pores.

These two characteristics are consistent with a decrease in the total thickness of the film 100 due to removal of the first layers 105 of silica without destruction of the subjacent porous structure.

The topography of the surfaces was observed by scanning electron microscopy (SEM) with a Hitachi 4100/ZEISS microscope using a field-emission gun. FIG. 7 shows an SEM image in top view of a mesoporous film 100 after removal of material. It shows the distribution of the cells 115 organized according to a crystallographic lattice consisting of domains with different orientations, the domains being delimited by domain boundaries 160 represented by black lines added to the photograph. The average size of a domain is about 0.02 μm².

According to another embodiment, an intense magnetic field can be applied at the time of preparation of the layers 105, in order to increase the size of these domains until a surface is obtained which consists of a monocrystalline lattice.

FIG. 9 shows an SEM image in sectional view of the mesoporous film after etching (the section was obtained by fracture). For comparison, FIG. 8 shows the same film, also in sectional view using the same technique, before etching.

The sectional views confirm the decrease in thickness from 11 to 8 layers, previously demonstrated by reflectivity (FIG. 6).

The SEM images also confirm that the Im3m symmetry expected for this film is such that the axis [110] of this symmetry is perpendicular to the plane of the surface.

These images also show that the slight distortion of the pores 110 after etching can be attributed to crushing of their circular section from 8 to 6 nm in the direction normal to the substrate.

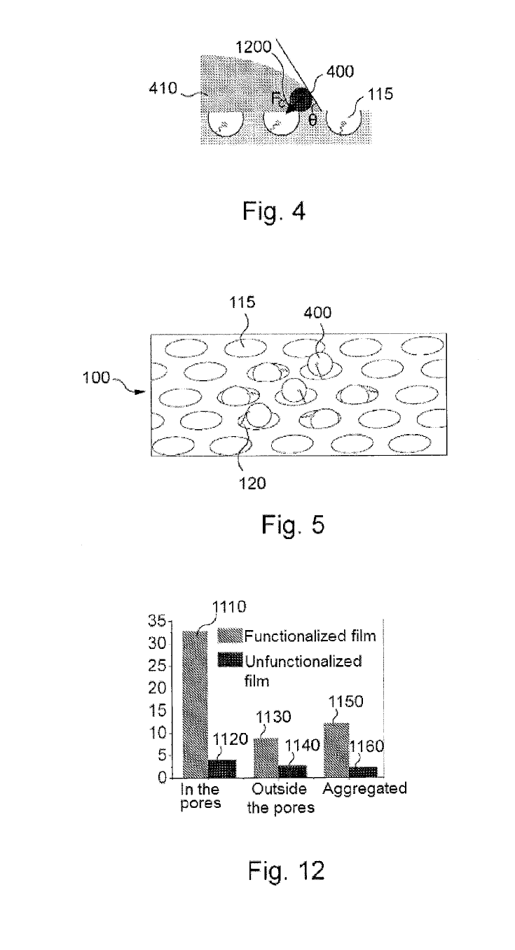

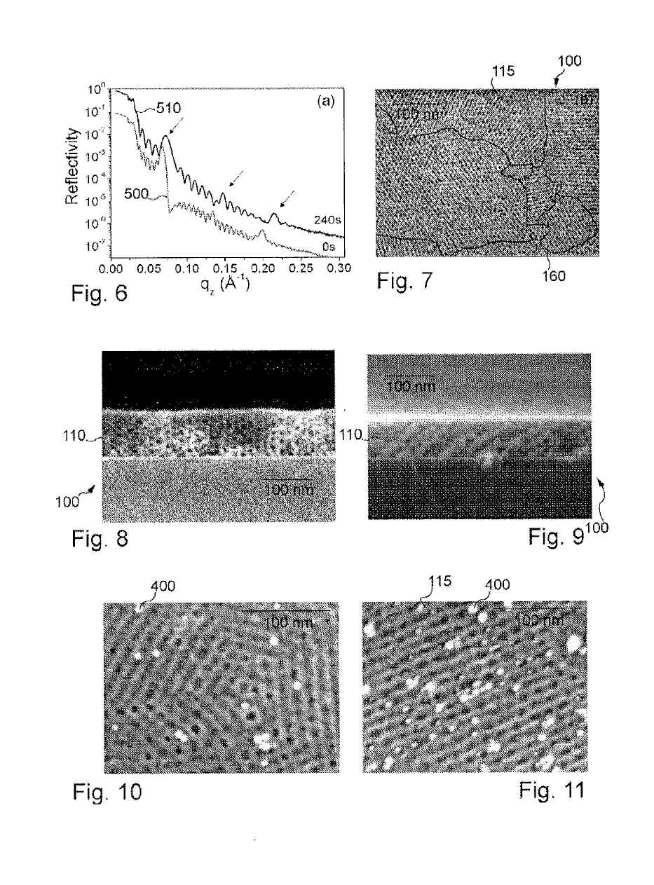

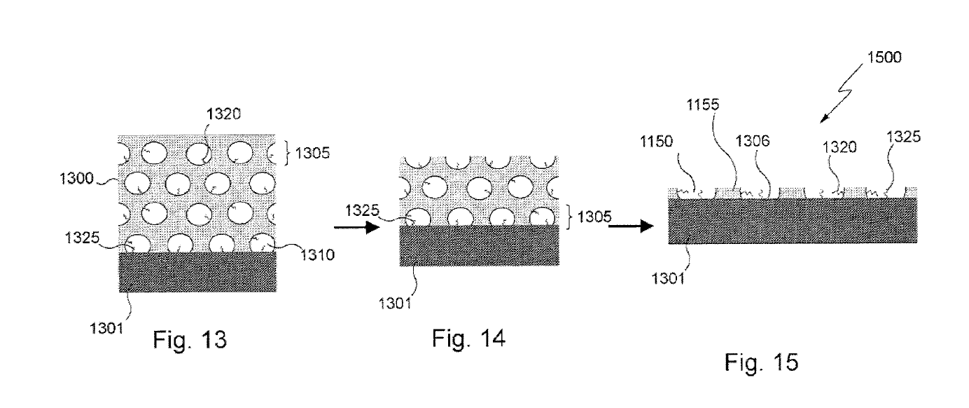

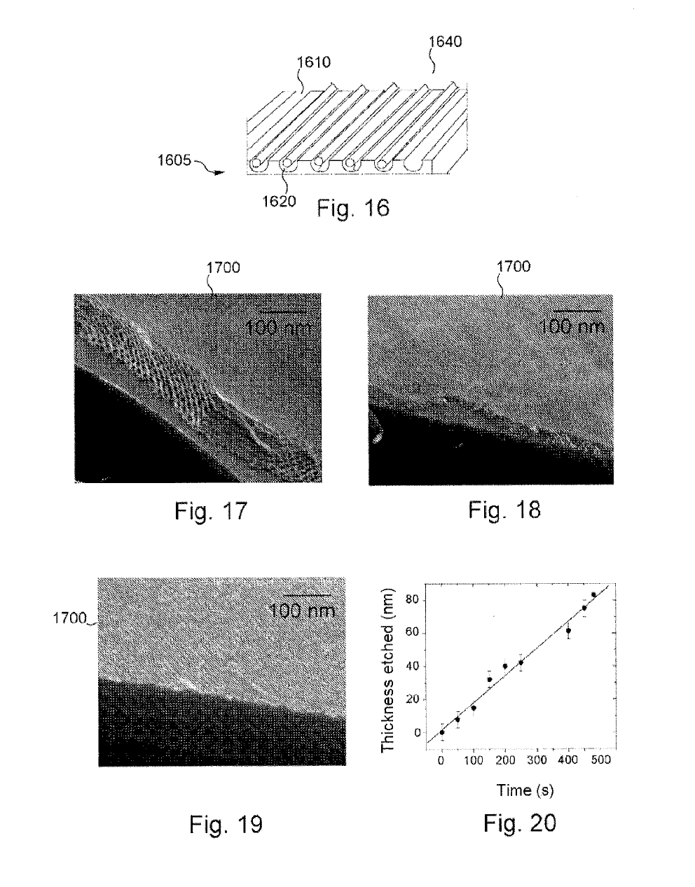

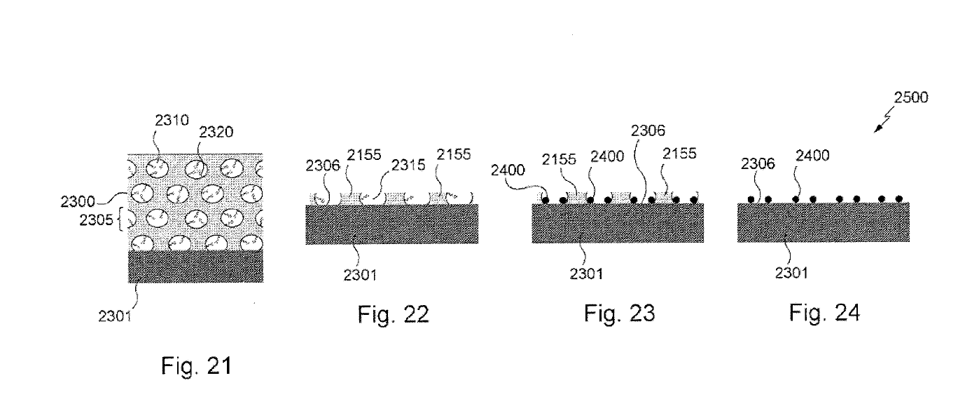

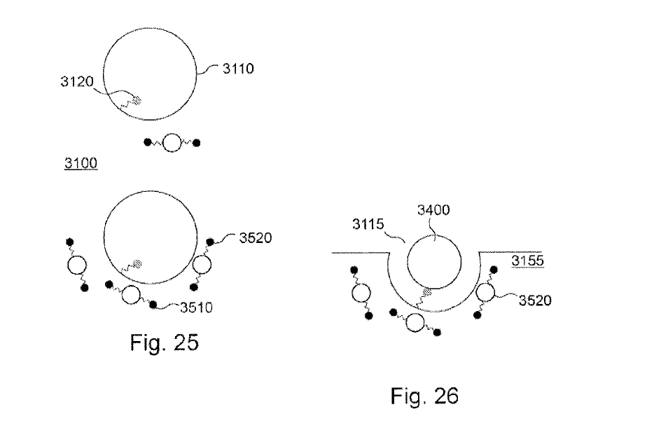

Referring to FIGS. 4 and 5, the nanostuctured surface of the thin film 100 consisting of monodisperse cells 115, organized according to a crystallographic lattice and having functions 120 selectively present on the surface of the cells, is used for grafting functional nanoparticles 400.

The surface of the pores 110 is grafted with cyanopropyl functions 120 capable of forming a complex with magnetic nanoparticles 400 of Fe—Pt (iron-platinum alloy). These spherical particles have a diameter of 3 nm and are soluble in aqueous solution on account of a ring of cysteine ligands (thiol function). They are presented in a solvent 410 during an impregnation step (FIG. 4).

Optionally, advantage is taken of the capillary force 1200 that is manifested during evaporation of the solvent 410. This capillary force Fc, which controls the geometry of the drop of solvent at the time of evaporation (illustrated by the contact angle □ in FIG. 4), promotes deposition of the particles in the cells 115.

For clarity, only one grafted nanoparticle 400 is shown per cell 115 (FIG. 5).

FIG. 11 shows SEM images of the distribution of nanoparticles 400 adsorbed on the open and functionalized mesoporous surface of the film 100. For comparison, FIG. 10 shows an open mesoporous surface that has not been functionalized (in the absence of functions 120).

The method of localization of the nanoparticles 400 is amplified considerably if additional chemical anchoring functions 120 are used on the cells 115 and the particles 400, as was seen in FIG. 2.

It in fact appears, on the basis of a visual inspection of the SEM images, that the number of isolated nanoparticles 400 in functionalized pores 110 is greater than the number of nanoparticles 400 adsorbed on the surfaces between the pores, called silica walls, and greater than the number of nanoparticles 400 present in the unfunctionalized pores 110.

This observation is confirmed by a statistical approach based on more than 1500 pores 110, the results of which are presented in FIG. 12. This shows a histogram presenting the number of nanoparticles 400 of Fe—Pt present in the cells 115 of a film 100 functionalized with cyanopropyl functions 120 (column 1110) and in the cells 110 of an unfunctionalized film 100 (column 1120).

The results show that the number of particles 400 in the cells 115 is 7 times higher for the functionalized film 100 than for the unfunctionalized film 100. Regarding the particles 400 observed outside of the cells 115, the ratio is much lower (columns 1130 and 1140 respectively), and this is also the case with respect to the aggregated particles 400 (columns 1150 and 1160 respectively).

According to this embodiment, the degree of filling of the pores 110 is of the order of 30% for the functionalized film 100.

This approach permits controlled localization of these particles 400 in applications as materials with high density of information storage. Such a network of particles 400 organized on a surface in particular makes it possible to orient the spins by application of a magnetic field B, and to reach the particles selectively, in a controlled manner, with the tip of a magnetic force microscope (MFM).

According to other embodiments, the degree of filling is higher, because of the change in the density of chemical functions grafted on the surface of the pores 110, additional functionalization of the particles 400 and of the pores 110, or adjustment of the ratio of the sizes of the particles 400 and of the cells 115.

According to another embodiment shown in FIGS. 1A to 1C, placement of a anchoring group on the surface of the mesopores is carried out by post-synthetic grafting, the steps of structuring of the mesoporous layer then being separate from the step of functionalization of the pores and prior to the latter. For this step, reference may be made, if necessary, to the literature, for example the review of A. Stein et al., Advanced Materials, 12, 1403 (2000).

To start with, the mesoporous material 700 comprising pores 710 is formed, and the surfactants are extracted to reach the state shown in FIG. 1A. This is followed by impregnation of the material 700 with a liquid solution 760 containing small molecules capable of diffusing through the microporosity of the material 700 (pores with diameters below 2 nm) (see FIG. 1B). These molecules are selected to react with silica under suitable conditions and, after removal of the solvent 760, anchoring groups 720 are present on the surface of the pores 710 (FIG. 1C identical to FIG. 2).

In another embodiment, groups are grafted by direct functionalization, then they are modified chemically and clusters (or macromolecules) are grafted thereon, post-synthetically.

According to another embodiment, shown in FIGS. 13 to 15, starting in FIG. 13 from a structure similar to that presented in FIG. 2 having layers 1305 of pores, the abrasion characteristics (FIG. 14) are adjusted to form nanostructured surfaces that allow the subjacent substrate 1301, on which the mesoporous material 1300 was deposited initially, to appear at the bottom of the cells 1150.

It should be noted that when the mesoporous material is deposited in this way on a substrate, numerous pores 1310 are opened on the substrate (FIG. 13). Therefore at the end of the etching process in FIG. 15, only a single layer of pores remains, and at least some pores forming cells 1150 are open to the exterior (FIG. 15, top), thus constituting a nanostructured surface 1500, and at the same time open towards the subjacent substrate 1301 (FIG. 15, bottom). Preferably, therefore, there are no longer any cells closed at the bottom by a base of mesoporous material, but the nanostructured surface consists of a succession of silica walls 1155 between exposure surfaces 1306 of the substrate 1301, by which the substrate 1301 is accessible through the cells 1150.

Advantage is then taken of the fact that etching by ion beam 200 is uniform down to very small layer thicknesses, which makes it possible to obtain a very uniform nanostructured surface 1500, the cells 1150 being very similar to one another.

Chemical functions 1320 are present in certain variants starting from the synthesis of the mesoporous material 1300, on account of functionalization by direct synthesis during preparation of the films of material 1310 (see above with respect to FIG. 2, and the use of functionalized precursors). These functions are preferably grafted specifically in the pores, on the surface of the latter with the functional head of the molecule directed towards the centre of the pore, or of the cell 1150, once the porosity is open. Alternatively, it has been possible to provide them by post-synthetic functionalization of the mesoporous material (not shown).

Other chemical functions 1325 can be added, this time on the surface of the substrate 1301 by post-synthetic functionalization (FIG. 13).

Thus, at the end of abrasion (FIG. 15), the exposure surfaces 1306 of the substrate 1301 carry functional groups 1325.

In a particular embodiment, the exposure zones 1306 are functionalized differently from the surface of the silica walls 1155. If functionalization of the mesoporous material is carried out post-synthetically, advantage is taken for this of the different chemical nature of these two surfaces by applying two different molecules by post-synthetic impregnation, one molecule being suitable for reacting with the silica, and the other with the substrate surface. The chemical groups 1325 are anchoring groups that aid linkage or complexation, such as a nitrile function.

According to a variant, also based on accessibility of the flush surfaces of the support through the pores, inorganic masks are thus formed for lithography, having sizes of patterns comprised between 2 and 50 nm (FIGS. 21 to 24).

Starting from a mesoporous film 2300 having layers 2305 the pores 2310 of which are functionalized by anchoring groups 2320, and which is placed on a support 2301 (FIG. 21), abrasion is carried out as previously (FIG. 22) so as to render surfaces 2306 of the substrate 2301 accessible through the cells 2315.

The chemical functions 2320 grafted on the surface of the walls of the pores 2310 are then utilized for anchoring nanoparticles 2400, for example metallic (FIG. 23). Coalescence of these particles thus gives rise to the formation of rings (or small cylinders) of controlled nanometric diameter, and organized opposite one another on the surface of the support 2301.

After removing the silica walls 2155 (FIG. 24), an assembly of rings 2500 is obtained, thus constituting masks and/or original nanostructures.

Referring to FIG. 16, according to another embodiment, cylindrical pores of mesoporous films in p6m hexagonal symmetry are open at the surface. In fact, depending on the type of surfactants used and their concentration introduced, it is possible to generate pores 1610 with different geometries, for example spherical or cylindrical. For example, the silica layers 1605 are structured by the surfactant P123, allowing the formation of cylindrical pores 5 nm in diameter organized in 2D hexagonal symmetry. Thus, the nanoparticles can be, besides spheres, also nanowires or nanotubes 1640, anchored by a anchoring group 1620.

The SEM images in sectional view presented in FIGS. 17, 18 and 19 are obtained after abrasion (etching) times of 50, 200 and 480 s. They reveal the presence of grooves 1700 aligned at the surface, organized like digital prints.

FIG. 20 shows that the etched thickness, as observed in these images, is linearly proportional to the abrasion (etching) time.

For the etching time of 480 s, shown in FIG. 19, the nanostructured film is only 4 nm thick. The etching is uniform down to the very small thicknesses.

According to other embodiments, the alignment of the pores is improved by the use of substrates having a pattern in relief beforehand, or by the application of an intense magnetic field at the time of preparation of the layers.

According to another embodiment, the method is employed for grafting diamond nanoparticles in cylindrical pores. The type of functionalization used is then amine functions grafted on the surface of the pores in order to form peptide bonds with carboxyl groups present on the surface of the particles. The nanoparticles are aligned in the cylinders for later use as reactors and formation of diamond nanowires.

In an embodiment shown in FIGS. 25 and 26, functionalization of the bulk of the silica film 3100 is also carried out by direct synthesis in addition to implantation of a anchoring group 3120 in the pores 3110. Functionalized bi-silylated silica precursors 3500 are added to the solution for synthesis of the mesoporous material. These precursors can comprise, between two silylated ends 3510, one or more functional groups 3520, which can be aryl groups, metals, and organic chemical functions, for example nitrogen-containing or oxygen-containing.

These molecules bearing two silylated ends 3510 undergo polycondensation with the rest of the silica network, bearing the functional groups 3520 to the centre of the silica walls. Thus, the material also comprises functionalization in its bulk (FIG. 25).

After abrasion (FIG. 26), these functional groups 3520 are inside the silica walls 3155 and are used for carrying out physical or physicochemical interactions with nano-objects 3400 positioned in the cells 3115 owing to the anchoring groups 3120, optionally over a distance from 5 to 25 Å or more. Atoms of the material of which the walls 3155 are constituted can be present in the intermediate space between the functional group 3520 and the nano-object 3400.

According to other variants, multi-functionalization of the pores is carried out with various functions in various proportions.

In other embodiments, the mesoporous material used is, instead of silica, a titanium oxide, obtained by means of a precursor such as titanium tetrachloride (TiCl4), or titanium isopropoxide (Ti(OiPr)4).

In other embodiments, the supports 101, 1300 or 2300 on which the mesoporous material is deposited consist of a material other than silicon, such as glass or gold, or another material displaying sufficient affinity with respect to the mesoporous material to obtain a homogeneous deposition of the film on the surface of the support. Moreover, the surface of any support material can be modified (in particular by depositing an intermediate layer, by a chemical or UV ozone treatment, etc.) to improve this affinity.

The invention is not limited to the embodiments presented, but includes the variants that are within the capacity of a person skilled in the art.

1. A method for preparing a functional structured surface comprising a controlled removal of a material from a film including at least one buried pore, wherein an internal surface of the pore comprises at least one chemical anchoring group, the controlled removal of the material comprising anisotropic abrasion such that a portion of the internal surface of the pore that is unaffected by the anisotropic abrasion on account of shading the from a mass around the pore is exposed.

2. The method according to claim 1 further comprising positioning nano-objects on the structured surface.

3. The method according to claim 2, wherein positioning nano-objects comprises a stabilization by chemical affinity employing the chemical anchoring group.

4. The method according to claim 2, wherein positioning nano-objects comprises deposition by impregnation.

5. The method according to claim 1, wherein the film includes at least one layer of pores, and at least some of the respective internal surfaces of the pores comprise chemical anchoring groups, and wherein the removal of material is carried out with conditions of duration, intensity and direction selected such that portions of the respective internal surfaces of the pores, unaffected by the removal of material, are exposed.

6. The method according to claim 1, wherein the removal of material comprises application of a beam with controlled incidence.

7. The method according to claim 6, wherein the beam comprises a beam of argon ions.

8. The method according to claim 1, further comprising forming the film including at least one pore beforehand from a liquid solution containing a precursor of the material.

9. The method according to claim 8, wherein the solution initially comprises a surfactant.

10. The method according to claim 8, wherein the solution contains molecules capable of reacting with the precursor for placement of an anchoring group on the surface of the pores.

11. The method according to claim 1, further comprising forming the at least one pore and adding at least one chemical anchoring group after forming the at least one pore.

12. The method according to claim 1, wherein the film includes at least one spherical pore.

13. The method according to claim 1, wherein the film includes at least one cylindrical pore.

14. The method according to claim 1, wherein the removal of the material is carried out so as to render accessible, via an internal space of the pore, a surface of a support underlying the film.

15. The method according to claim 14 further comprising adding a chemical anchoring group on the surface of the support.

16. The method according to claim 14 further comprising removing residues of the film after positioning of nano-objects (2400) on the structured surface.

17. The method according to claim 1, wherein the film comprises one of oxides of silicon, titanium, zinc or aluminium.

18. The method according to claim 1, wherein the chemical anchoring group comprises a nitrile function.

19. The method according to claim 1, the film further comprises chemical groups capable of exchanging charges in a bulk region of the film.

20. A functional structured surface comprising at least one mesopore cell, the surface of which comprises at least one chemical anchoring group.

21. A nanostructured surface obtained by a method according to claim 1.

22. The method according to claim 3, wherein positioning nano-objects comprises deposition by impregnation.
